(19) United States
(12) Patent Application Publication
(10) Pub. No.: US 2022/0362905 A1
(43) Pub. Date: Nov. 17, 2022

(54) APPARATUS FOR VERIFYING THE PRESENCE, OR THE ABSENCE, OF AN ABRASIVE ELEMENT IN A MACHINE FOR WORKING SURFACES

(71) Applicant: FABRICA MACHINALE S.R.L, Cascina (IT)

(72) Inventors: Luca BOSIO, Pisa (IT); Renzo VALLEGGI, Cascina (IT)

(73) Assignee: FABRICA MACHINALE S.R.L, Cascina (IT)

(21) Appl. No.: 17/625,993

(22) PCT Filed: Jul. 7, 2020
(86) PCT No.: PCT/IB2020/056360

§ 371 Date: Jan. 10, 2022

(30) Foreign Application Priority Data
Jul. 11, 2019 (IT) 102019000011454

(51) Int. Cl. B24B 49/10; B24D 9/08; B24B 27/00

(52) U.S. Cl. CPC B24B 49/10; B24D 9/085; B24B 27/0038

(57) ABSTRACT

An apparatus for verifying the presence, or the absence, of an abrasive element in a machine for finishing surfaces comprising a support body configured to removably engage the abrasive element. The support body and the abrasive element are, respectively, provided, at respective engagement surfaces with first and second engagement elements configured to move from an engagement configuration to a disengagement configuration, and vice versa. Furthermore, a displacement device is provided to move the support body in the space according to at least 1 degree of freedom. The apparatus, furthermore, provides at least a control station equipped with a control device comprising a control element having a control surface provided with third engagement elements configured to engage with the first engagement elements of the support body, and a detection device configured to detect if an engagement between the control element and the support body has taken place.

### FIELD OF THE INVENTION

The present invention relates to the technical field of the machines that are used for working surfaces that are able to move an abrasive element in the space, according to at least two degrees of freedom, and in particular it relates to an apparatus for detecting the presence of an abrasive element in a machine for working surfaces.

Furthermore, the invention relates to a method for carrying out such a verification.

### BACKGROUND OF THE INVENTION

As known, in order to carry out the operations for finishing surfaces made of different materials such as pottery, wood, plastic materials, metallic materials, etc. in order to improve their shape, and their tribological properties grinding machines, or sanding machines, equipped with an abrasive element, typically an abrasive disc, are commonly used.

In the automatic industrial machines for finishing surfaces of known type, an abrasive disc is moved with respect to the surface to be worked by an anthropomorphic arm, or however by a support that is mounted on guides in such a way that is possible to move the abrasive element at least in two different movement directions. Normally, the abrasive element is constrained to a support by engagement elements arranged to provide a removably engagement, for example by means of Velcro, or an adhesive tape, or also by elements that are able to provide a threaded coupling. In this latter case, a threaded blind hole that is made in the support and a threaded shaft protruding from the abrasive element, at the surface opposite to the abrasive surface, which, in working conditions, applies the abrasive action on the worked surface are provided. A very common type of threaded connection between support and abrasive disc, usually known in the technical field as “ROLOC”, is, for example, described in U.S. Pat. No. 3,562,968.

After a certain number of working cycles, it is, anyway, necessary to replace the abrasive element, which, unavoidably, during working operations wears out, and, therefore, is no more able to exert an effective abrasive action.

Normally, the replacement operation of the abrasive element is carried out manually by an operator con with consequent loss of time, and productivity decreasing for the machine. Furthermore, the manual replacement of the abrasive element brings with it the risk to apply the new abrasive disc to the support in a wrong way, and therefore that, during the working operations, the abrasive disc can be removed from the correct position, thus compromising the operation.

In order to overcome the aforementioned drawbacks in WO2015/125068 an apparatus is provided that is able to carry out automatically the replacement of an abrasive element. In particular the solution described in WO2015/125068 provides a removal station in which a removal device operates that is provided with a sharp edge. It is, furthermore, provided a displacement device to move the support with respect to the removal device up to obtain a removal position in which the sharp edge is interposed between the abrasive element and the support and, therefore, causes the abrasive element to be detached from the support. In these machines at least a detection device is, furthermore, provided to verify at the end of the application operation the presence of a new abrasive element at the backing pad, or the absence of the same between a removal and an application operations. In this way, if the removal operation has failed, it is avoided that the displacement device can move the support body at an application station, where the presence of the worn abrasive element would make it not possible to apply the new abrasive element, or that the backing pad not provided with the abrasive element due to an incorrect positioning of the new abrasive element, could be moved at the surface to be worked with the risk to damage the same. Usually, the detection device comprises a colour detection sensor. Therefore, the abrasive surface of the abrasive element is, normally, of a different colour with respect to the engagement surface of the support body. Therefore, depending on the colour that is detected, the colour detection sensor is able to verify the presence, or the absence, of the abrasive element at the support body.

However, this solution does not seem to be satisfactory. In fact, after some working cycles dusts of material removed from the worked surface can adhere to the surface of the abrasive element, thus compromising the correct detection of the colour by the colour detection sensor and, therefore, screw the result of the aforementioned detection operation.

Analogous problems are also encountered with optical detection sensors of different kind, such as photocells, also in this case due to the presence of dusts adhering to the surface of the abrasive element.

Other examples of machines for working the surfaces with analogous drawbacks are described in WO2019/123310, FR2999107 and DE102012006502.

### SUMMARY OF THE INVENTION

It is, therefore, an object of the present invention to provide an apparatus for verifying the presence of an abrasive element in a machine for finishing surfaces, in particular a grinding machine, a polishing machine, or a sanding machine, which allows to overcome the aforementioned drawbacks of prior art solutions.

It is, in particular, an object of the present invention to provide a similar apparatus that is able to accurately detect the presence, or the absence, of an abrasive element at the support, or backing pad of the machine for finishing surfaces.

It is also an object of the present invention to provide a method for verifying the presence of an abrasive element in a machine for finishing surfaces, in particular a grinding machine, a polishing machine, or a sanding machine, that has the aforementioned advantages with respect to the methods used in the prior art.

These and other objects are achieved by an apparatus, according to the invention, to verify the presence, or the absence, of an abrasive element in a machine for finishing surfaces, said machine comprising:
a support body configured to removably engage said abrasive element, said support body and said abrasive element being, respectively provided, at respective engagement surfaces, with first engagement elements and second engagement elements configured to move from an engagement configuration to a disengagement configuration;
a displacement device configured to move said support body in the space according to at least 1 degree of freedom;
   whose main characteristic is that said apparatus, furthermore, comprises at least a control station of the presence, or absence, of said abrasive element at said support body, and that said control station provides a control device comprising:
a control element having a control surface provided with third engagement elements configured to engage with said first engagement elements of said engagement surface of said support body, said displacement device being arranged to bring said support body, or the abrasive element integral to the same, if present, into contact with said control surface of said control element and to cause said support body to be moved; and
a detection device configured to detect if any engagement has taken place between said support body and said control element, during said movement of said support body by said displacement device.

Other technical characteristics of the invention and relative embodiments are defined in the dependent claims.

According to another aspect of the invention, a method for verifying the presence, or the absence, of an abrasive element in a machine for finishing surfaces provides the steps of:
providing a support body configured to removably engage said abrasive element, said support body and said abrasive element being provided, at respective engagement surfaces, of mutual engagement elements configured to move from an engagement configuration to a disengagement configuration;
providing a displacement device configured to move said support body in the space according to at least 1 degree of freedom;
   whose main characteristic is that the steps are, furthermore, provided of:
providing a control element having a control surface provided with engagement elements configured to engage with said engagement elements of said engagement surface of said support body;
bringing said support body, or said abrasive element engaged to said support body, if present, into contact with said control surface;
displacing said support body by said displacement device after having brought said support body into contact with said control surface; and
detecting if any engagement has taken place between said support body and said control element, said detecting step being carried out by a detection device during said movement of said support body by said displacement device.

### BRIEF DESCRIPTION OF THE DRAWINGS

The invention will be now illustrated with the following description of an exemplary embodiment thereof, exemplifying but not limitative, with reference to the attached drawings wherein:

FIG. 1A diagrammatically shows a side elevational perspective view of a possible embodiment of an apparatus, according to the invention, for verifying the presence, or the absence, of an abrasive element in a machine for finishing surfaces;

FIG. 1B diagrammatically shows a side elevational perspective view of an enlargement of a portion of FIG. 1A in order to highlight some technical characteristics;

FIG. 1C diagrammatically shows a disassembled configuration of an abrasive element and a support body according to the invention in order to highlight some technical characteristics;

FIG. 2A diagrammatically shows a side elevational perspective view of an alternative embodiment of the apparatus of FIG. 1A for verifying the presence, or the absence, of an abrasive element in a machine for finishing surfaces;

FIG. 2B diagrammatically shows a side elevational perspective view, of an enlargement of a portion of FIG. 2A in order to highlight some technical characteristics;

FIG. 3 diagrammatically shows in side elevational perspective view of the apparatus of FIG. 1A in a working step;

FIG. 4 diagrammatically shows a side elevational perspective view of a possible working configuration of the apparatus, according to the invention, to verify the presence, or the absence, of an abrasive element in a machine for finishing surfaces;

FIG. 5 diagrammatically shows a side elevational perspective view of an embodiment according to the invention for a control device of which the apparatus of FIG. 1A can be equipped with;

the FIGS. 6A and 6B diagrammatically show a side elevational perspective view of a possible working configuration of the apparatus of FIG. 1A, in the case that the abrasive element is still engaged to the support body;

FIG. 7 diagrammatically shows a side elevational perspective view of a possible working configuration of an alternative embodiment of the apparatus of FIG. 4 to verify the presence, or the absence, of an abrasive element in a machine for finishing surfaces;

FIG. 8 diagrammatically shows a front elevational perspective view of a possible embodiment provided for the control element of which the apparatus according to the invention is equipped with;

FIG. 9 diagrammatically shows a side elevational perspective view of still another alternative embodiment of the apparatus of FIG. 1;

FIG. 10 diagrammatically shows in side elevational perspective view of an enlargement of a portion of FIG. 9 in order to highlight some technical characteristics.

### DETAILED DESCRIPTION OF SOME EXEMPLARY EMBODIMENTS OF THE INVENTION

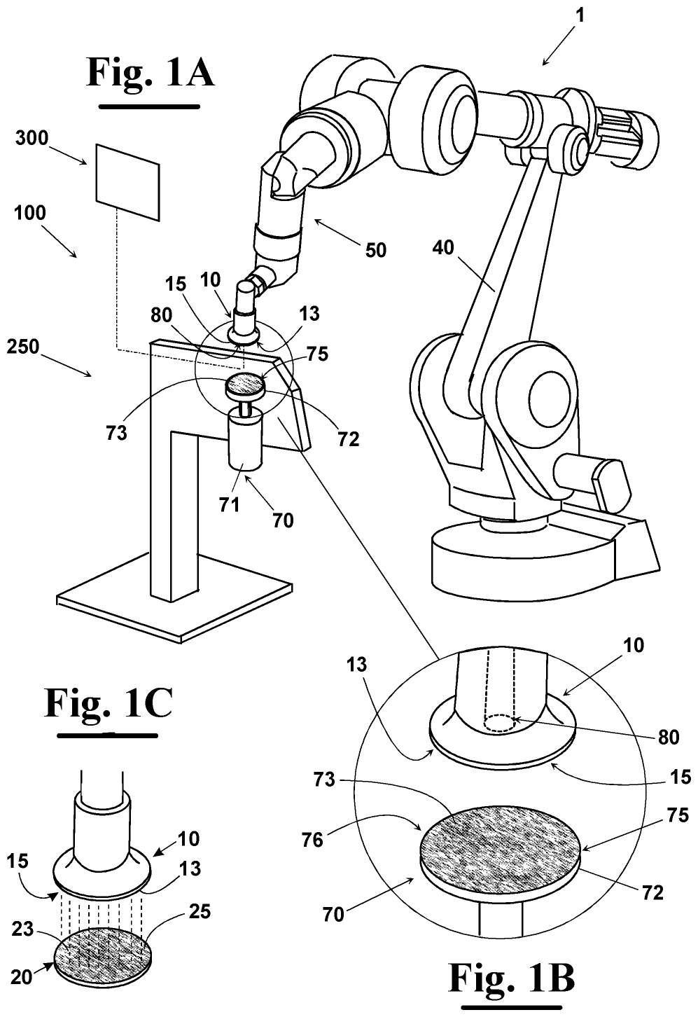

In FIG. 1A, an apparatus 100, according to the invention, for verifying the presence, or absence, of an abrasive element 20 in a machine for finishing surfaces 1, in particular at a support body 10, or backing pad, of the same is diagrammatically shown. More precisely, the apparatus 100 can be provided with a working head 50 integral to the aforementioned support body 10 having an engagement surface 15 arranged to engage the engagement surface 25 of an abrasive element 20. This, at the side opposite to the engagement surface 25, is preferably provided with an abrasive surface 24 arranged to provide a grinding action at the surface to be worked. More precisely, the support body 10 and the abrasive element 20, at the respective engagement surfaces 15 and 25, are provided with first and second engagement elements 13 and 23 configured to reversibly mutually engage with each other (see FIG. 1C). These are configured to move from an engagement configuration to a disengagement configuration, or vice versa. According to an embodiment of the present invention, the aforementioned first and second engagement elements 13 and 23 can bee, respectively, first and second portions of predetermined size of a touch fastener arranged to reversibly mutually engage with each other, also called, respectively, “male Velcro” and “female Velcro”. Alternately, the aforementioned first and second engagement elements 13 and 23 can be arranged to snap engage one with the other. In this case, the first engagement elements 13 can comprises at least a protrusion 13 and the second engagement elements at least a recess 23, or vice versa.

The apparatus 100, according to the invention, furthermore, provides a displacement device 40 configured to move the support body 10 in the space according to at least 1 degree of freedom. Even though in the figures from 1A to 7, the displacement device 40 is diagrammatically shown as a anthropomorphic robot, in fact, the displacement device 40, according to the invention, can be configured to move the support body 10 according to one, or more, translational degrees of freedom, or one, or more, rotational degrees of freedom, or according to a combination of movements comprising at least a translational degree of freedom and a rotational degree of freedom and overall according to a number of degrees of freedom comprises between 2 and 6. In particular, the displacement device 40 can be configured to cause at least a rotation of the support body 10 about a rotation axis 110 with respect to the working head 50. It is foreseen the possibility that the finishing machine 1 is of a roto-orbital machine and, therefore, that, the displacement device 40 is configured to move the support body 10, in such a way that the same describes an eccentric orbit with respect to the axis of the working head 50.

According to the present invention, furthermore, the apparatus 100 provides at least a control station 250 to verify the presence, or the absence, of the abrasive element 20 at the support body 10. More in particular, the aforementioned control station 250 is equipped with a control device 70. This comprises a control element 75 provided with a control surface 76 equipped with third engagement elements 73 configured to engage with the first engagement elements 13 of support body 10. For example, the third engagement elements 73, as well as the second engagement elements 23, can provide at least a portion of “female Velcro”, or “male Velcro”. In the first case, the first engagement elements 13 are constituted by at least a portion of “male Velcro”. In the second case, instead, the first engagement elements 13 are constituted by at least a portion of “female Velcro”. Analogously, in the case that the first and the second engagement elements 13 and 23 provide at least a protrusion 13 and at least a recess 23, or vice versa, arranged to snap engage one with the other, the third engagement elements 73 provide, respectively, a recess, or a protrusion.

More precisely, the verification of the presence, or absence, of the abrasive element 20 at the support body 10, provides that the aforementioned displacement device 40 brings the support body 10 same, or, if present, the abrasive element 20 constrained to the same, into contact with the control surface 76 of the control element 70. Then, the displacement device 40 is operated in such a way to cause a movement of the support body 10, for example a translation along a predetermined direction, or a rotation, or a combination of movements. However, in general, the displacement device 40 can be arranged to apply a predetermined force, in particular a detachment force, to move the support body 10 away from the control element 75.

More in particular, the apparatus 100 provides also a detection device 80 configured to detect any engagement of the support body 10 with the aforementioned control element 75. In particular, the detection device 80 is configured to carry out the aforementioned detection, once that the support body 10, or the abrasive element 20 engaged to it, if present, has been positioned into contact with the control element 75 and has been moved by the displacement device 40.

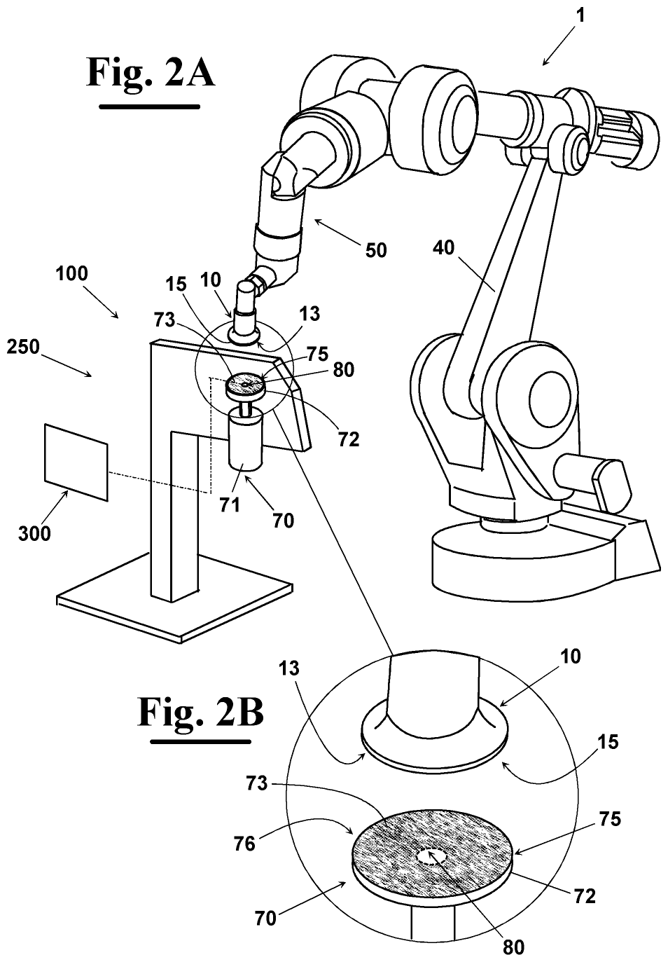

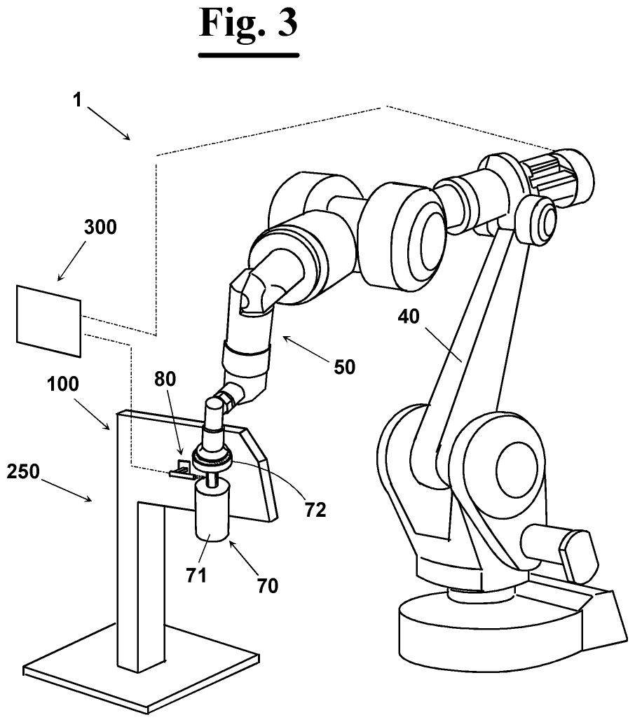

More in detail, according to a possible embodiment, the detection device 80, can be configured to detect the force applied by the displacement device 40 at the support body 10 (FIGS. 1A and 1B), or the control element 75 (FIGS. 2A and 2B), to move the support body 10 with respect to the control element 75.

In particular, in the embodiment shown in the FIGS. 1A and 1B, the detection device 80 is provided integral to the support body 10. In this case, if after having brought the support body 10 into contact with the control element 75 will be necessary, by the displacement device 40, to apply a force greater than a predetermined threshold value, to cause the aforementioned movement of the support body 10, will mean that the aforementioned engagement between the support body 10 and the control element 75 has taken place.

Instead, if the force that is necessary to cause a displacement of the support body 10 will be less than the aforementioned threshold value, will mean that the support body 10 has not been engaged, due to the presence of the abrasive element 20 constrained to the same, to the control element 75.

In the embodiment shown in the FIGS. 2A and 2B, instead, the detection device 80 is provided integral to the control element 75. In this case, if an engagement between the support body 10 and the control element 75 takes place, the movement of the support body 10 by the displacement device 40 will produce a force on the control element 75 greater than a predetermined threshold value. Instead, if the support body 10 and the control element 75 does not engage with each other, the force that will be applied on the control element 75 during the aforementioned movement will not be able to produce any force on the control element 75, or anyway a force less than the aforementioned predetermined threshold value.

Both in the embodiment shown in the FIGS. 1A and 1B, and in the embodiment shown in the FIGS. 2A and 2B, the detection device 80, advantageously, comprises at least a force sensor.

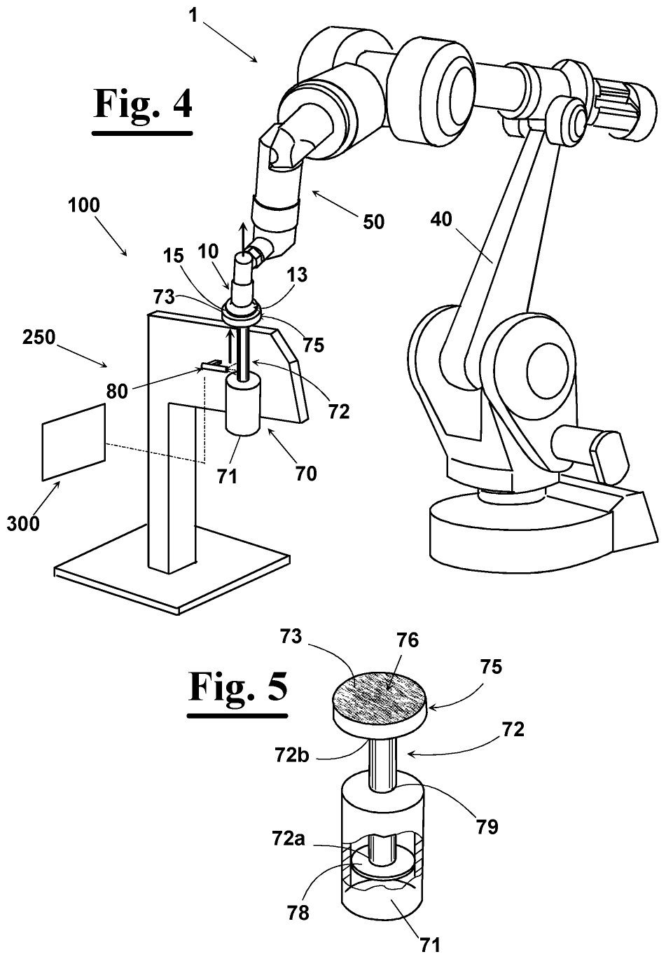

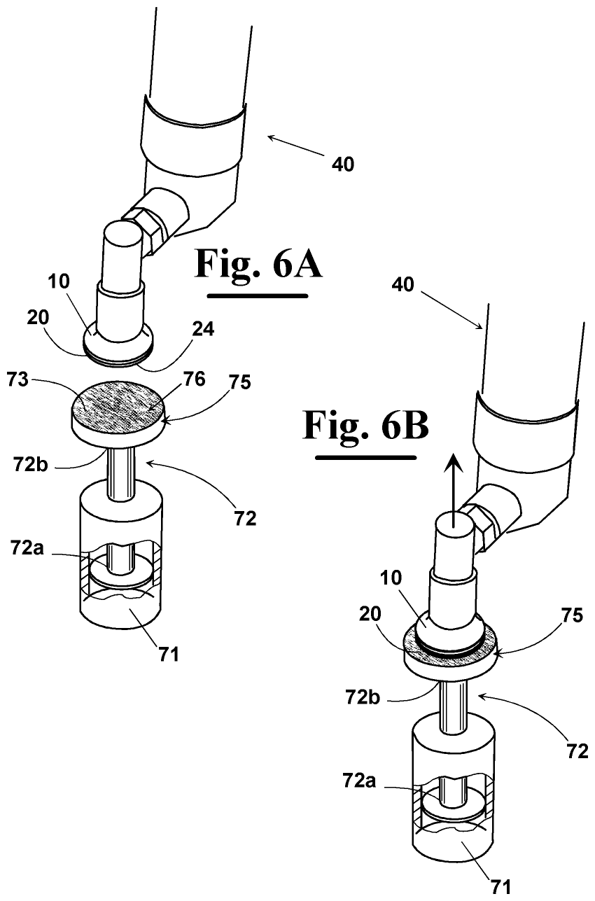

In the figures from 3 to 7 some possible alternative embodiments of the present invention are shown, in which the control element 75 can move with respect to a fixed base body 71. In this case, the detection device 80 can be advantageously configured to detect any movement of the control element 75 with respect to the fixed base body 71, during the aforementioned movement of the support body 10 by the displacement device 40. More precisely, in the case that the abrasive element 20 is not present at the support body 10, the third engagement elements 73 of the control surface 76 engage with the first engagement elements 13 of the engagement surface 15 of the support body 10. Therefore, the aforementioned movement caused by the displacement device 40 will cause a movement of the control element 75 that will be, therefore, detected by the detection device 80 (FIG. 4).

Instead, in the case that the abrasive element 20 is present at the support body 10, as diagrammatically shown in the FIGS. 5A and 5B, the aforementioned first and third engagement elements 13 and 73 cannot engage with each other, because the third engagement elements 73 will enter into contact with the abrasive surface of the abrasive element 20 and not with the engagement surface 15 provided with the first engagement elements 13 of the support body 10. Therefore, the detection device 80 will not detect any movement of the control element 75 with respect to the fixed base body 71, or, anyway, a movement shorter than a predetermined displacement Δs, due to the interaction between the support body 10, or more precisely between the abrasive element 20 and the control element 75.

More in detail, according to the embodiments shown in the figures from 3 to 7, the detection device 80 can comprise, advantageously, at least a movement sensor and/or at least an accelerometer and/or at least a rotation sensor and/or at least an encoder and/or at least a limit position sensor.

In the example that is diagrammatically shown in the figures from 4 to 6B, the control element 75 is configured to translate with respect to the fixed base body 71. In this case, therefore, the displacement device 40 is, advantageously, arranged to cause the support body 10 to translate along a predetermined translation direction.

In the alternative embodiment of FIG. 7, instead, the control element 75 is configured to rotate about a first predetermined rotation axis 175 with respect to the fixed base body 71. In this case, therefore, the displacement device 40 will be arranged to cause the support body 10 to rotate about a second predetermined rotation axis 110. Advantageously, the rotation axis 175 and the rotation axis 110 can be parallel one another, in particular coincident, or can be inclined at a predetermined angle one with respect to the other.

According to an embodiment, diagrammatically shown in particular in FIG. 5, the fixed base body 71 is hollow, for example with cylindrical shape, and a stem 72 is provided having an end 72a slidingly mounted within the cavity of the fixed base body 71, and the opposite end 72b fixed to the verification element 75. In this case, the detection device 80 can be configured to detect the displacement of the control element 75 by detecting the displacement of the stem 72.

In particular, the control device 70 can provide a stop element 78 configured to stop the movement of the control element 75 with respect to the fixed base body 71. More in particular, in the example of FIG. 5, the stop element 78, once that a predetermined limit position is reached, can be arranged to cause the first engagement elements 13 and the third engagement elements 73 to disengage from each other after a predetermined translation stroke, or a predetermined rotation, of the control element 75 with respect to the fixed base body 71.

Advantageously, the stop element 78 can be configured to move the control element 75 back to a starting position with respect to the fixed base body 71. According to a possible embodiment of the invention, the stop element can be an elastic element, for example a linear spring, or an actuator, in particular a pneumatic actuator, advantageously with adjustable pressure, as diagrammatically shown in FIG. 5, arranged to oppose the aforementioned displacement by applying a predetermined force. More in particular, in this case, the force applied by the stop element on the control element 75 is substantially constant.

According to the present invention, it is possible to move in sequence the displacement device 40 for positioning the same in different positions with respect to the control element 75. In this way, it is possible to avoid that the missing engagement of the first and the third engagement elements 13 and 73 can be caused by a not correct relative positioning between the support body 10 and the control element 75 and, therefore, that the missing detection by the detection device 80 could be skewed.

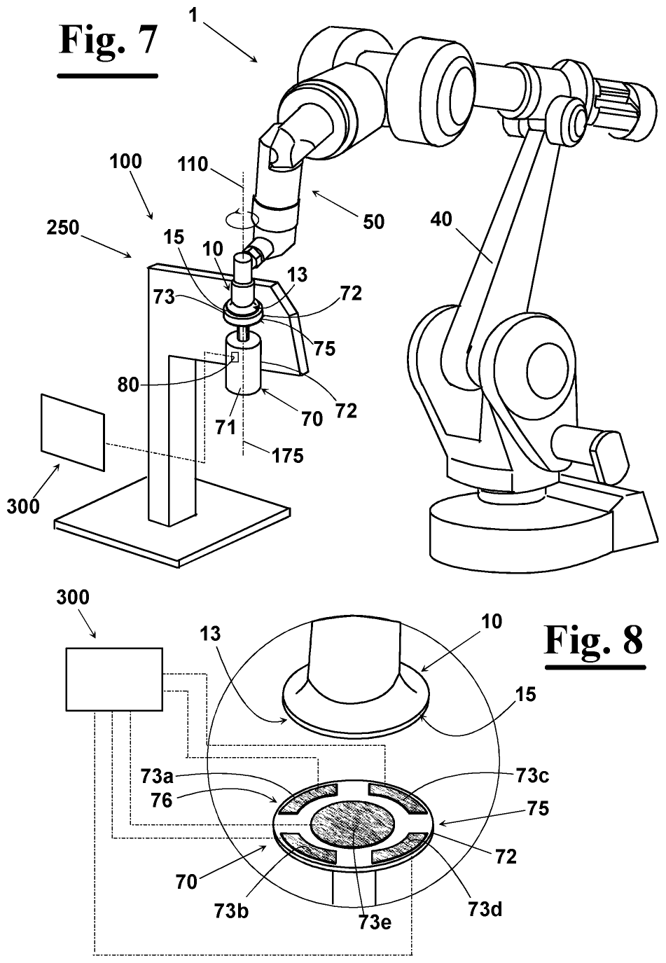

In the further alternative embodiment of FIG. 8, the control element 75 is provided with a plurality of control surfaces 73, in the case that is shown in FIG. 8, 5 control surfaces 73a-73e. In particular, each control surface 73a-73e can be provided with a sensor working independently from the others. More in particular, the aforementioned detection device 80 can, in this case, provide a plurality of detection elements, not shown in the figures for simplicity, each of which operatively connected to a respective control surface 73a-73e, in such a way to detect if any engagement have taken place, or not, with the respective portion of the support body 10. This solution allows to detect, in particular, the presence of one, or more, fragments, of the abrasive element 20 engaged with the support body 10 also after having carried out a removal operation. In fact, in particular in the presence of aqueous solutions, during a working cycle, the abrasive element 20 can beak apart and, therefore, considerably reduce its surface and produce a fragment, or more, fragments separated one from the others. Therefore, in these cases, it is possible that the removal operation can fail.

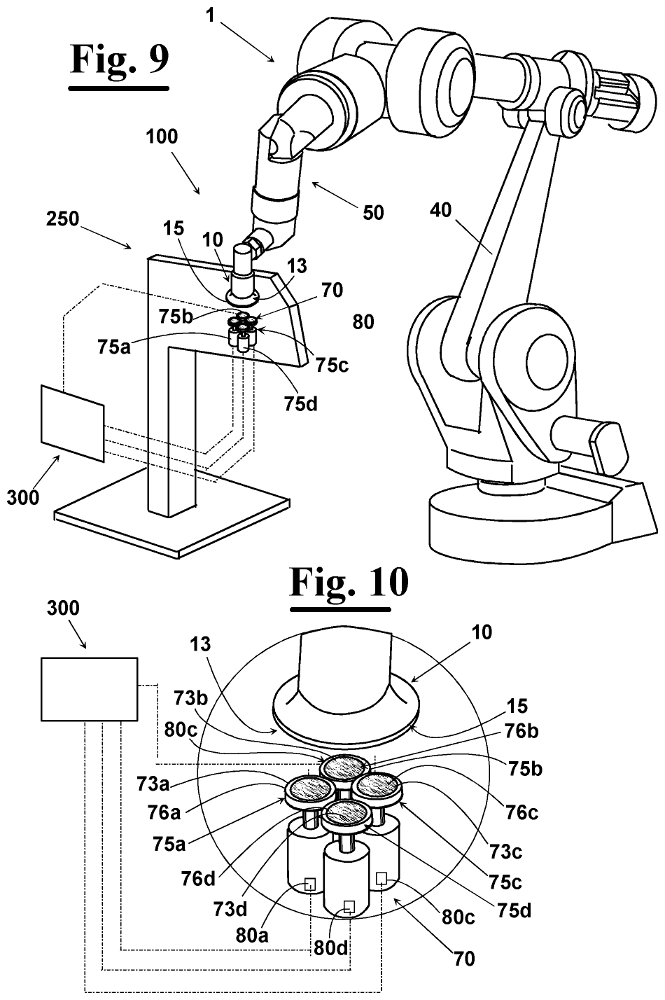

In the further alternative embodiment diagrammatically shown in the FIGS. 9 and 10, the control device 70 comprises a plurality of control elements 75, for example 4 control elements 75a-75d. Each control element 75a-75d has a respective control surface 76a-76d provided with respective third engagement elements 73a-73d, each of which configured to engage with said first engagement elements 13 of the support body 10, or with a predetermined portion of the same. In this case, each control element 75a-75d can be advantageously associated to a respective detection device 80a-80d, each of which configured to detect if any engagement between the respective control element 75a-75d and the support body 10, or more precisely, a respective portion of this, has taken place, during the movement of the support body 10 by the displacement device 40.

Therefore, in this way, it is possible to detect very accurately also the presence of a single fragment, or portion, of an abrasive element 20 at the support body 10 in a very selective and accurate way.

It is also foreseen the possibility that the stop element is a passive pneumatic actuator arranged to generate a negative pressure, and not a positive pressure, as in the previous case, on a configurable reservoir. In particular, in this case the force applied by the stop element on the control element 75 is an increasing force.

As diagrammatically shown in the figures from 1A to 10, the apparatus 100 can comprise, furthermore, a processing unit 300 configured to receive and elaborate the data detected by the detection device 80 and in case to command the displacement device 40 to repeat the verification, in particular both after having verified the presence, or the absence of the abrasive element 20 at the support body 10, or to go back to a removal station if present and carry out the removal operation of the abrasive element 20 from the support body 10, in case that the presence of the abrasive element 20 at the support body 10 has been detected, or to an application station and carry out the application of a new abrasive element 20 to the support body 10, in case that the absence of the abrasive element 20 at the support body 10 has been verified.

According to the invention, in fact, the apparatus 100, in addition to the aforementioned machine for finishing surfaces 1, as described above, can comprise at least a removal station, not shown in the figures for reasons of simplicity, configured to remove the worn abrasive element 20 from the support body 10 and/or at least an application station, also this not shown in the figures for reasons of simplicity, for applying a new abrasive element 20 all support body 10. In particular, the aforementioned control station for verifying the presence, or absence, of the abrasive element 20 at the support body 10 can be positioned between the removal station and the application station of a new abrasive element 20.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. An apparatus to verify the presence, or the absence, of an abrasive element in a machine for finishing surfaces, said machine comprising:
a support body configured to removably engage said abrasive element, said support body and said abrasive element being, respectively, provided, at respective engagement surfaces with first and second engagement elements configured to move from an engagement configuration to a disengagement configuration, and vice versa;
a displacement device configured to move said support body in the space according to at least 1 degree of freedom;
the apparatus comprising at least a control station is provided to verify the presence, or the absence, of said abrasive element at said support body and in that in said control station a control device is provided comprising:
a control element having a control surface provided with third engagement elements configured to engage with said first engagement elements of said support body, said displacement device being arranged to bring said support body, or the abrasive element constrained to the same, if present, into contact with said control surface of said control element and to cause a movement of said support body; and
a detection device configured to detect if an engagement between said control element and said support body has taken place, during said movement of said support body by said displacement device.

2. Apparatus according to claim 1, wherein said detection device is configured to detect the force applied by said displacement device on said support body, or said control element, to move said support body with respect to said control element, after having brought said support body, or the abrasive element constrained to the same, if present, into contact with said control element.

3. Apparatus according to claim 1, wherein said control element is operatively connected free to move to a fixed base body, and wherein said detection device is configured to detect lo displacement of said control element with respect to said fixed base body caused by said movement of said support body with respect to said control element, after having brought said support body, or the abrasive element constrained to the same, if present, into contact with said control element.

4. Apparatus according to claim 1, wherein said detection device is selected from the group comprising:
at least a force sensor;
at least a movement sensor;
at least an accelerometer;
at least a rotation sensor;
at least an encoder;
at least a limit position sensor;
or a combination thereof.

5. Apparatus according to claim 1, wherein a stop element is, furthermore, provided configured to stop said movement of said control element with respect to said fixed base body, and to cause said first engagement elements to be disengaged from said third engagement elements.

6. Apparatus according to claim 5, wherein said stop element is configured to move said control element back to a starting position with respect to said fixed base body.

7. Apparatus according to claim 1, wherein said control element is configured to translate with respect to said fixed base body, and wherein said displacement device is arranged to cause said support body to translate along a predetermined translation direction.

8. Apparatus according to claim 1, wherein said control element is configured to rotate about a first predetermined rotation axis with respect to said fixed base body, and wherein said displacement device is arranged to cause said support body to rotate about a second predetermined rotation axis of.

9. Apparatus according to claim 3, wherein said fixed base body is hollow and is a stem is provided having an end slidingly mounted within said fixed hollow base body and another end fixed to said control element, said detection device being arranged to detect the displacement of said control element by detecting of the displacement of said stem.

10. Apparatus according to claim 1, wherein said first and second engagement elements are arranged to snap engage one with the other.

11. Apparatus according to claim 1, wherein said first and second engagement elements comprise, respectively, first and second portions of Velcro arranged to reversibly mutually engage with each other.

12. Apparatus according to claim 1, wherein said displacement device is a anthropomorphic robot having a number of degrees of freedom set between 2 and 6.

13. Apparatus according to claim 1, wherein said control device comprises a plurality of control elements, wherein each control element is provided with a respective control surface provided with respective third engagement elements, and wherein each third engagement element is configured to engage said first engagement elements of said support body, or a predetermined portion of the same.

14. Apparatus according to claim 13, wherein each control element of said plurality is associated to a respective detection device, each of which configured to detect if an engagement of the respective control element with a respective portion of said support body has taken place, during the movement of said support body by said displacement device.

15. Apparatus according to claim 1, wherein a processing unit is, furthermore, provided configured to receive and elaborate the data detected by said detection device.

16. Apparatus according to claim 15, comprising, furthermore, at least a removal station configured to remove said worn abrasive element by said support body, said processing unit being configured to command said displacement device to position again at said control station to verify again the presence, or the absence, of said abrasive element at said support body, or, after having verified at said control station the presence of said support element on said support body, to go back to said removal station and to carry out a removal operation of said abrasive element from said support body.

17. Apparatus according to claim 15, comprising, furthermore, at least an application station configured to apply a new abrasive element to said support body, said processing unit being configured to command said displacement device, to position again at said control station to verify again the presence, or the absence, of said abrasive element at said support body, or after having verified in said control station the absence of said abrasive element at said support body to go back to said removal station and carry out an application operation of said new abrasive element at said support body.

18. Apparatus according to claim 17, wherein said control station is positioned between said removal station and said application station.

19. A method for verifying the presence, or absence, of an abrasive element in a machine for finishing surfaces provides the steps of:
providing a support body configured to removably engage said abrasive element, said support body and said abrasive element being provided, at respective engagement surfaces, respectively of first and second engagement elements configured to move from an engagement configuration to a disengagement configuration;
providing a displacement device configured to move said support body in the space according to at least 1 degree of freedom;
providing a control element having a control surface provided with third engagement elements configured to engage with said first engagement elements of said engagement surface of said support body;
bringing said support body, or said abrasive element engaged to said support body, if present, into contact with said control surface;
displacing said support body by said displacement device; and
detecting if any engagement between said control element and said support body have taken place, by a detection device, during said movement of said support body by said displacement device.

20. Method, according to claim 19, wherein said detection step is repeated at least two times.
